(19) United States
(12) Patent Application Publication
(10) Pub. No.: US 2003/0084034 A1
(43) Pub. Date: May 1, 2003

(54) Web-based search system

(76) Inventor: Richard Fannin, Redmond, WA (US)

Correspondence Address: Stuart T. Langley, Esq., Hogan & Hartson, LLP, Suite 1500, 1200 17th Street, Denver, CO, 80202, US

(21) Appl. No.: 10/036,766

(22) Filed: Nov. 1, 2001

(51) Int. Cl. G06F 7/00

(52) U.S. Cl. 707/3

(57) ABSTRACT

A method of accessing web-based search services from a client computer involving communicating request and response message traffic between a first instance of a web browser executing on the client computer and a search engine service executing on a web server. Using a client executable process, search terms are captured from at least one of the messages. The search terms are used to index into a local data structure on the client computer and retrieve an address of a web site associated with the search terms. A second instance of a web browser is launched on the client machine. The second instance of a web browser is directed to the address of the web site retrieved from the local data structure.

### BACKGROUND OF THE INVENTION

1. Field of the Invention

The present invention relates, in general, to systems and methods for network navigation, and, more particularly, to software, systems and methods that use client-side agents to initiate application behavior that augments search services provided by on-line search engines.

2. Relevant Background

The World Wide Web provides access to information in the form of “web pages” which typically comprise mark-up language documents, controls, and executable program components in the form of scripts or applets. Web pages are viewed using a client application such as a web browser. Web pages are delivered to a user's machine by network-connected servers called “web servers” executing any of a variety of available web serving software. Messages are exchanged between web browser processes and web server processes using a compatible protocol such as hypertext transfer protocol (HTTP) and usually additional protocol layers such as transmission control protocol (TCP)/Internet Protocol(IP).

Every web page is identified by a unique address referred to as a uniform resource locator (URL). A URL indicates the Internet application protocol being used (e.g., HTTP for web pages) and a domain name associated with the server associated with the page. For example, a URL for the U.S. Patent Office is:

HTTP://www.uspto.gov

where HTTP indicates the protocol and the domain is “uspto.gov”. Although HTTP is a familiar format, URLs use a wide variety of other protocols including file transfer protocol (FTP), news protocol (NNTP), secure protocols (e.g., HTTPS and FTPs) among others. Depending on the particular transaction, a URL will include other information such a path pointing to a particular directory, and a file name, active server page (asp) identifier, or the like that appears in the directory. URLs may also be associated with information in the form of parameters, and state information in the form of cookies.

In IP networks (e.g., the Internet), the domain name is associated with a specific IP address of a web server. A public domain name system (DNS) is used to maintain a mapping of domain names to IP addresses. A web browser uses a software process called a resolver to obtain a mapping of a domain name to a particular IP address. A client-server interaction is initiated by a client computer issuing an HTTP request message addressed to a particular URL corresponding to a web server. Once the URL is resolved to an IP address, the HTTP request is transported over TCP/IP to the server at the IP address.

In cases where the URL could not be resolved, an error message is generated by the DNS system so indicating. Similarly, even when the URL does resolve to an IP address, if the host at the IP address does not recognize the request or have the requested resource, or any of a number of other error conditions occur in attempting to service the request, the server will generate a response having an error code indicating the error. Familiar error codes include HTTP 404 errors for a resource that could not be found, and HTTP 403 errors indicating the requester does not have permission or authority to view the resource. These are typically displayed on the client machine as a page indicating the numerical error code, or may be translated by the browser into a more user friendly format (e.g., “the page cannot be found”). However, in either case the user is left back as square one trying to locate a particular resource.

Absent an error condition, upon receipt of an HTTP request the web server locates or generates a responsive web page and transmits it to the requesting client in one or more HTTP response messages. Other types of servers may use other protocol response messages. The response message is addressed to the IP address of the client computer, and includes information identifying the content type and the content itself. In a web-based example, the response usually includes HTML page which may include active contents such as applets, ActiveX controls, and JavaScript constructs.

Using the above-described system a user must know the URL for a desired resource to locate the resource with a browser. If the user does not know the URL or just wants to find information on a particular topic, the user uses a search engine. A search engine is a service that maintains a directory or database of network content and associated keywords, or the equivalent. Despite many architectural variations, search engines in general operate to receive keywords from a searcher and use the keywords to index into the database and return a set of candidate URLs. The URLs are usually presented to the searcher in the form of hyperlinks embedded in an HTML document (e.g., a search results page).

Because searching in this manner is very inexact, it is unlikely that the search engine will identify one specific web site that is specifically what the searcher was looking for. As a result, search engines refrain from launching a browser window with a particular site identified by the search. Instead, the user peruses tens or hundreds of search result links and selects particular links based on the link name or a brief description of the content to be found at that link. It is widely recognized that this search strategy is imprecise and produces haphazard results. Moreover, the results depend highly upon both the skill of the user in writing queries and upon the types of words used by web page writers, both in what is written for explicit viewing and in the selection of metatags that are used to attract search engines.

Because search engines are such a commonly used tool for locating network content, they present a unique opportunity for advertising. At one level, the sheer number of users that access the Internet, for example, via a search engine makes the search engine's pages valuable advertising real estate. Further, when a user submits a search request the user has identified himself or herself as desiring immediate information, often about particular goods or services desired by the user. This information can be used alone or coupled with historical information about past searches stored in the form of cookies to provide a highly valuable profile of the searcher's needs. Advertisers desire such information so that they can target advertisement specifically.

A variety of technologies have developed to exploit the information developed by search engines. Many search services that host search engines, for example, allow advertisers to purchase space or ranking in the search results for particular keywords. Hence, the first page of links returned to the user may not contain the most relevant links, but instead will contain a set of links that is biased in favor of particular advertisers. In other cases, the results page is returned with targeted banner advertisements based on the search strategy. These advertising strategies are criticized because the manner in which advertisements are presented cannot be readily controlled by either the searcher or third parties who do not desire to purchase advertising services from the search engine site.

More recently, search engines have been returning pages with “pop-up” or “pop-under type” advertisements where new browser windows are opened automatically to specific advertising web pages either upon entry or exit from the results page. Like the other advertising strategies, the pop-up and pop-under advertisements are entirely controlled by the search engine presentation logic and cannot be readily controlled by either the searcher or third parties who do not desire to purchase advertising services from the search engine site. To date, these pop-up and pop-under windows have not been targeted to the search terms, and instead appear regardless of the current search strategy.

Because each search engine offers a different mix of performance, most people use a variety of search engines for various tasks. Advertisers find this a difficult development because they must purchase advertising services from multiple search engines to achieve a desired and uniform result. This redundant advertising increases costs which are passed on to consumers in the form of higher prices. There is a need for a search technology that provides easy to use search services and returns highly relevant information in a manner that expresses preferences of users and third party service providers.

A fundamental limitation of many search engine architectures is that they are essentially designed to index text-based materials. Search engines gather information about web pages using agents such as web crawlers and spiders and the like. These tools may fail to properly index non-text material such as graphics and multimedia content, therefore rendering this valuable material less accessible. Many site owners and content providers would prefer to select the keywords associated with a site rather than have those words automatically determined by a robot. Hence, there remains a need for a search engine that provides easy to see access to information contained in databases that are not easily found by existing web crawlers and search engines.

### SUMMARY OF THE INVENTION

Briefly stated, the present invention involves method of accessing web-based search services from a client computer involving communicating request and response message traffic between a first instance of a web browser executing on the client computer and a search engine service executing on a web server. Using a client executable process, search terms are captured from at least one of the messages. The search terms are used to index into a local data structure on the client computer and retrieve a URL that either identifies an address of a web site associated with the search terms, identifies an address of a auxiliary search engine, or both. The web browser is directed to the URL of the web site retrieved from the local data structure. In some cases, a first instance of the web browser is directed to cause a search to be performed on the search engine service, and a second browser window is directed to the identified URL to augment the search performed by the search engine service.

In another aspect, the present invention involves a system for locating network content using a plurality of network-accessible search engine servers. A client is configured to send search request messages to the network-accessible search engine servers and receive response messages containing search results from the search engine servers. A search assistant process executing on the client captures search terms from at least one of the request messages and response messages and uses the captured search terms to locate a network resource associated with the search terms.

In yet another aspect, the present invention provides a search assistant process that monitors response traffic of a browser application to identify error messages received by the browser. In response to the error message, the search assistant process directs the browser to an alternative resource. In one example, the alternative resource displays a page of intelligently selected options that will guide the user towards a network server that either contains the subject matter that is being sought by the user, or the equivalent.

### BRIEF DESCRIPTION OF THE DRAWINGS

FIG. 1 shows a networked computer environment in which the present invention is implemented;

FIG. 2 shows a particular implementation of the present invention in block diagram form;

FIG. 3 illustrates and exemplary data structure used by the search assistant in accordance with the present invention;

FIG. 4 is a flow diagram of processes in a search transaction in accordance with an embodiment of the present invention;

FIG. 5 is a flow diagram of an alternative process in a search transaction in accordance with the present invention; and

FIG. 6 is a flow diagram of another alternative process in accordance with the present invention.

### DETAILED DESCRIPTION OF THE PREFERRED EMBODIMENTS

The present invention involves implementation of a “search assistant” program or process on a client machine. The search assistant implements behaviors that preferably augment rather than replace the functions of search engines, although in practice it may replace the function of particular search engines. The invention is described in terms of an Internet-based application for locating and retrieving web pages or web sites (i.e., HTML documents), but is readily adapted to retrieve any type of content over any type of network, including client/server and peer-to-peer networks.

In general, the present invention is implemented as a plug-in or add-on to a conventional browser program. In particular implementations, the invention listens to or monitors request/response traffic from the browser, parses the requests and/or responses, and initiates custom behavior based on various parts of a URL or parameters associated with the URL. Action may be initiated based upon parameters (e.g., search terms), domain, error codes, or any other part of a URL. The action is preferably determined by looking up the action in a local data structure that contains associations between the part of the URL and a specified action. The specified actions typically are stored as URLs that point to specified network resources that will lead to information relevant to the user.

The present invention is illustrated and described in terms of a distributed computing environment such as an enterprise computing system using public communication channels such as the Internet. However, an important feature of the present invention is that it is readily scaled upwardly and downwardly to meet the needs of a particular application. Accordingly, unless specified to the contrary the present invention is applicable to significantly larger, more complex network environments including a plurality of local networks such as Fibre Channel, Ethernet, FDDI and Token ring, as well as small network environments such as conventional LAN systems.

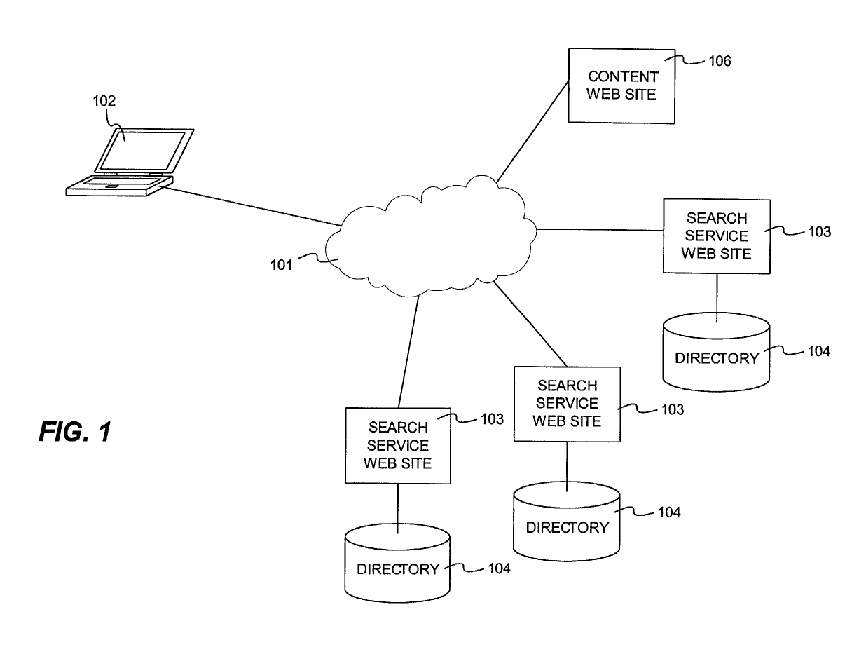

FIG. 1 shows an exemplary computing environment 100 in which the present invention may be implemented. Essentially, a number of computing devices and groups of devices are interconnected through a network 101. In a practical network implementation, a plurality of clients 102 would coupled to network 101 either directly, through routers, hubs, switches or other networking hardware, or through Internet service providers, for example. Client 102 comprises a computer having sufficient computing resources and memory to implement desired data processing behavior. In most applications, client 102 may range in complexity from a multiprocessing supercomputer or workstation to conventional personal computers or laptop computers. It is contemplated that client 102 may be implemented on thin client hardware such as web tablets, hand-held computers, and computing appliances such as cell phones and the like as well.

Network 101 supports connections to a variety of services implemented by server software and hardware. For example, search service web sites 103 respond to search requests generated by client 102 to provide network locations (e.g., uniform resource locators) corresponding to particular network-accessible resources such as content web site 106. In practice, a network has thousands or millions of network-accessible resources which may provide content, data processing, electronic commerce, and any number of other services, all of which can be indexed in the directory databases 104 of search services 103.

Each of the devices shown in FIG. 1 may include memory, mass storage, and a degree of data processing capability sufficient to manage their connection to network 101. The computer program devices in accordance with the present invention are implemented in the memory of the various devices shown in FIG. 1 and enabled by the data processing capability of the devices shown in FIG. 1. In addition to local memory and storage associated with each device, it is often desirable to provide one or more locations of shared storage that provides mass storage capacity beyond what an individual device can efficiently use and manage. Selected components of the present invention may be stored in or implemented in shared mass storage.

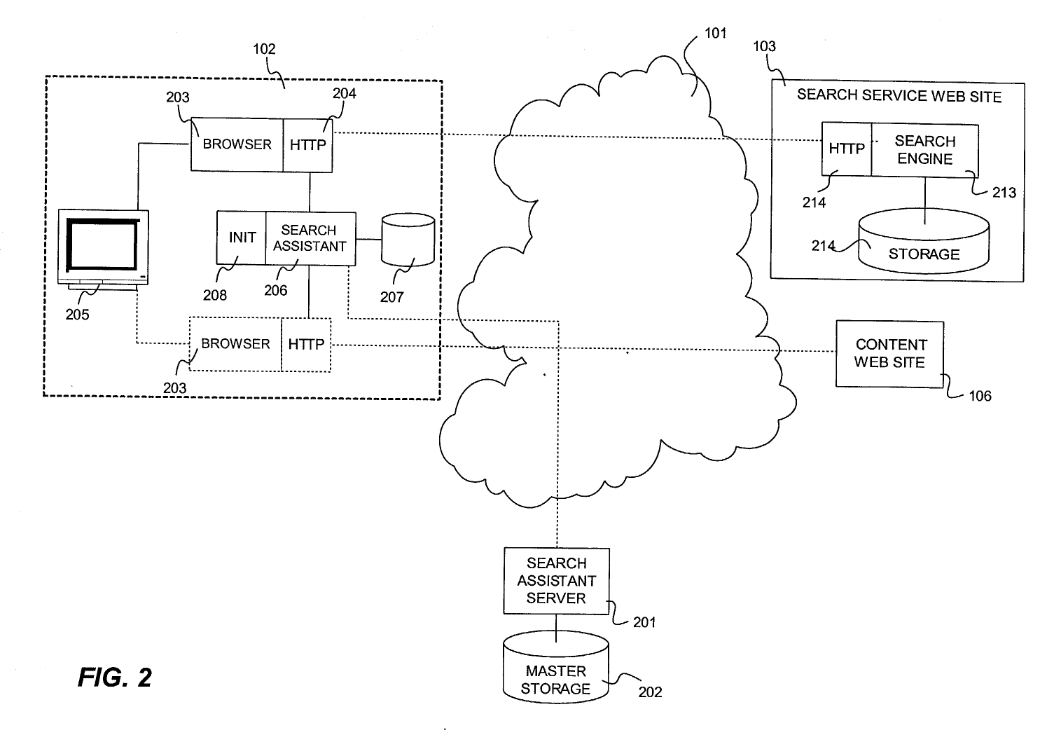

FIG. 2 illustrates a particular implementation of the present invention in block diagram form showing some of the elements of FIG. 1 in greater detail. In addition to the components shown in FIG. 1, the present invention is preferably implemented with a search assistant server coupled to network 101 so at to be accessible to client 102. In one alternative, content web site 106 is also able to access search assistant server 201, either directly or through network 101, to manipulate the contents of master storage 202 within permitted boundaries. Search assistant server 201 manages a master storage area 202 that contains copies of search assistant code and data used to implement instances of search assistant 206 and search assistant local data structure 207 in a client 102. It is contemplated that the search assistant 206 will be occasionally updated to implement new behaviors for particular applications, but that search assistant local data structure 207 will be more frequently updated to reflect new search augmentation strategies.

In a practical implementation, many thousands of clients 102 will be outfitted with search assistant 206 and local data structures 207. It is not required that the implementation in each of these clients 102 be identical. For example, a unique version of data structure 207 may be associated with a group of users that belong to a particular organization, age group, Internet service provider, or demographic. The grouping of people is arbitrary. However, that group will receive particular search assistant behaviors based upon their group membership, enabling custom-tailored performance designed to meet specific user needs. Groups may be as small as one member, and arbitrarily large. It is contemplated that local data structures 207 will be updated frequently either by processes within search assistant 206 that pull the updates from search assistant server 201, or by push technologies managed by search assistant server 201, or a hybrid of these techniques.

Client 102 includes an instance of a browser application 203, which couples to a graphical or multimedia display device 205. Browser 203 can be implemented using any available web browser software such as Microsoft Internet Explorer, Netscape Navigator, IBM Explorer, NSCA Mosaic and the like. Browser 203 functions to render HTML pages, including active components such as ActiveX controls, Java Script and Applets, into a graphical user interface displayed via display device 205. Browser 203 implements or is coupled to an HTTP interface 204 that communicates with HTTP interfaces of server programs through network 101. The network, transport and physical link layer software is omitted from FIG. 2 for ease of illustration and understanding, however, these elements would typically be provided to meet the needs of a particular application.

In a typical search session, browser 203 exchanges HTTP messages with search service web site 103, which includes an HTTP interface 214 to a search engine server 213 application 213. An HTTP message conforms, for example to the HTTP/1.1 standards set out in IETF RFC 2068 which is incorporated herein by reference, although it is contemplated that other message formats and protocols including later versions of HTTP may be readily substituted.

An HTTP request message includes a request method, a host domain identification, and a uniform resource locator. For example, a search conducted against the URL in the request message:

GET/bin/search?p=search+engine+patents HTTP/1.1 Host: search.yahoo.com

the method is “GET”, the host is “search.yahoo.com” and the locator information includes the path “/bin/search”. The example search request message above also includes parameters that will be used by search engine 103 to conduct the search for locations associated with the search terms “search”, “engine” and “patents”. Most search engine interfaces constrain the number and length of search terms, as well as the manner in which they can be logically combined, but these are limitations of the search engines 103 themselves and not important for the operation of the present invention.

Search engine 213 interprets the HTTP requests and formulates and executes searches against a directory or database stored in storage area 214. Search engine 213 then formulates an HTTP response message addressed to client 102 including a response page having a set of links to web sites selected by the search engine 213. In the exemplary response message:

HTTP/1.1·200·OK

Date:·Wed,·11·Jul·2001·22:43:44·GMT

Connection:·close

Content-Type:·text/html

Set-Cookie:·B=a0eva7ktkpll0&b=2&f=s;·expires=

Thu,15·Apr·2010·20:00:00·GMT;·path=/;·domain=.yahoo.com

[Content]

a status code 200 is included indicating that the target resource in the search service web site 103 was found, various metadata, a set-cookie method for exchanging state information with client 102, and content which includes a plurality of lines of HTML code that form the results page. The results page might display a URL in an address window of a browser that looks like:

http://search.yahoo.com/bin/search?p=search+engine+patents

In accordance with the present invention, search assistant 206 listens to the message exchange between client 102 and search service web site 103. This listening is relatively easy to implement as most browser software implements application programming interfaces to browser 203 and/or HTTP interface 204 that enables HTTP traffic to be monitored. Search assistant 206 may be coupled to monitor all HTTP messages or only HTTP messages from a preselected set of domains that are known to correspond to search service web sites.

Search assistant 206 captures data from the headers and/or content of the HTTP messages when the messages relate to search requests and responses. In practice, search assistant 206 listens to all request/response messages, although it may only initiate action for certain types of messages, such as those related to a search engine request. This can be detected by the domain names and/or IP addresses associated with the requests. However, it is contemplated that even non search engine related requests may be used to trigger action by search assistant 206. For example, any request containing the string “patent” in the domain or parameters may be handled by search assistant 206 to point the browser 203 to www.uspto.gov.

In a particular example, a short list of domains including yahoo.com, infoseek.com, altavista.com, google.com and the like within search assistant 206 will enable discrimination of search messages from other messages. Alternatively, a list of keywords related to searches such as “query?”, “search?”, and the like appear in many search engine request/response messages and may be used to trigger capture of message headers and/or content.

In a particular implementation, search assistant 206 includes an “init” interface that enables search assistant 206 to initialize a supplementary browser instance 203 indicated in phantom in FIG. 2. The supplementary browser instance 203 is substantially equivalent to the primary browser instance 203 discussed hereinbefore, including functionality to implement a GUI on display device 205 and access network content via an HTTP interface. Search assistant 206 exercises the ability to launch secondary browser instances 203 upon capturing a search-related message having search terms that match a specified keyword stored in local search assistant data structure 207. Search assistant 206 is able to direct the secondary browser instance 203 to any desired location by supplying a URL during the browser initialization process. In a particular implementation, search assistant local data structure 207 provides a particular URL associated with the keyword(s) so that browser 203 opens to a location (e.g., content web site 106) that is ultimately determined by the search terms specified by the user in the search messages.

In this manner, search assistant 206 augments the search strategy by opening a new browser window in display device 205 that displays web pages from content web site 106, or a web page having links to content web site 106. This may occur whether or not search service 103 returns any links to content web site 106. Preferably, the primary instance of browser 203 displays the search results from search service web site 103 in a conventional manner, so that the web-based search services are augmented and improved, not replaced.

In an alternative implementation that may be preferred in some instances, search assistant 206 uses the primary browser instance 203 to present information from content web site 106 before presenting the actual search results from the search service 103. In this implementation, search assistant 206 acts as a “mezzanine” search service in that it not only augments the original search service 103, but may in fact prevent its display for a period of time, or prevent its display entirely. This function can have significant benefit to both the user and the search service 103 as it can prevent a request reaching search service 103 thereby reducing the load on computing resources of search service 103, and conserving network bandwidth. Search service 103 can use search assistants 206 to handle common search requests, while less common search requests are forwarded to search service 103 for handling. In many cases users may request or authorize the replacement of the web-based search services such that only the results initiated by search assistant 206 are presented. In such cases, the preferred implementation includes a link that, when selected by a user, causes the search to be applied to original search service 103 if the user determines that the augmenting search results are not sufficient.

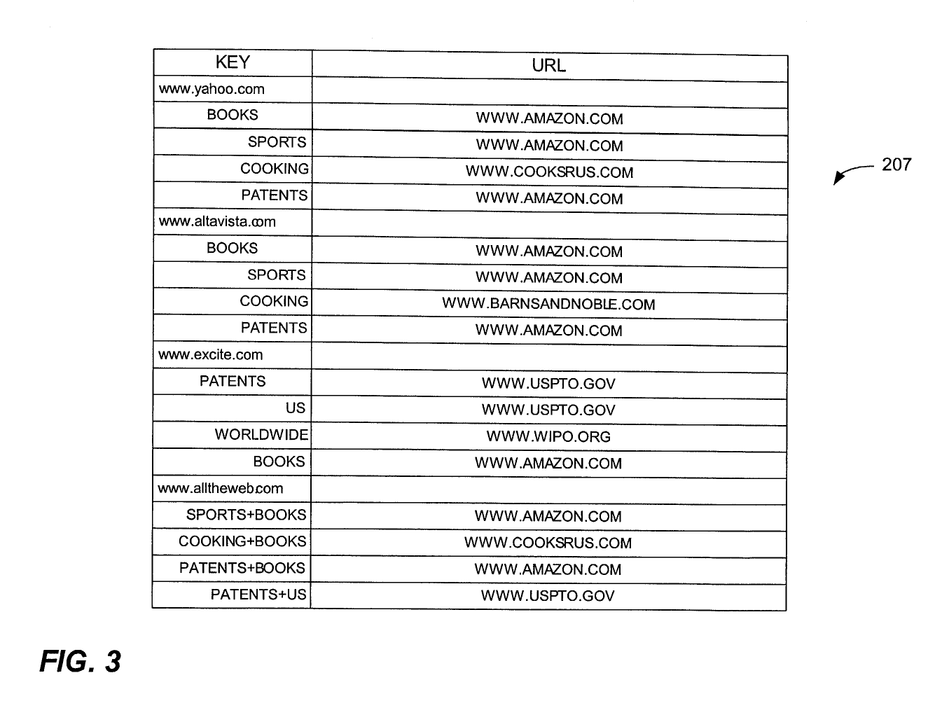

FIG. 3 illustrates and exemplary local data structure 207 used by the search assistant in accordance with the present invention. Local data structure 207 is associated with a master copy maintained and distributed by search assistant server 201. Essentially, data structure 207 comprises a plurality of entries where each entry holds a key:value pair. Data structure 207 may be implemented as a flat or hierarchical data structure, and may be implemented as a list, table, LDAP or X.500 directory, or database depending on the needs of a particular application.

As shown in FIG. 3, the keys may be divided into sections corresponding to specific domains of search engines. In this manner, a separate set of keys may be associated with each search service web site. Alternatively, a single set of keys may be applied to all search service web sites irrespective of domain. Key values generally contain one or more generic words that often appear as search terms. In some instances, a key may comprise a single word, whereas in others the key comprises two or more words combined into a logical expression. Hence, key may comprise the logical expression “Books AND Sports” while another key comprises the logical expression “Books OR Sports”.

In FIG. 3, the sections corresponding to yahoo.com, altavista.com and excite.com represent a hierarchical structure whereas the section corresponding to alltheweb.com illustrates a flat structure. Each entry also includes URL data such that the URL and key values of a given entry create an association or binding. In the hierarchical structures for yahoo.com a keyword such as “BOOK” is associated with a particular URL, but a subordinate keyword “COOKING” which corresponds to a search for both the terms BOOK and COOKING is associated with another URL. By including various levels of hierarchy a relatively complex set of bindings between keys and URLs can be represented. Alternatively, in the flat key representation the key value takes the form of a logical expression that is matched to particular search terms.

In operation, some or all of the search terms captured by search assistant 206 are used to index into the key values in data structure 207 to select an entry having a key value matching the search terms. The URL of the associated entry is then returned to search assistant 206 and used to point any instances of supplementary browser 203. It is contemplated that more than one URL may be contained in a given entry. In such cases, all URLs in an entry may be returned allowing search assistant 206 to instantiate a supplementary browser for each URL. Alternatively, a single URL may be selected randomly, arbitrarily, or according to some prioritization scheme such that only a single supplementary browser 203 is launched for any search request, but over time all of the URLs are used.

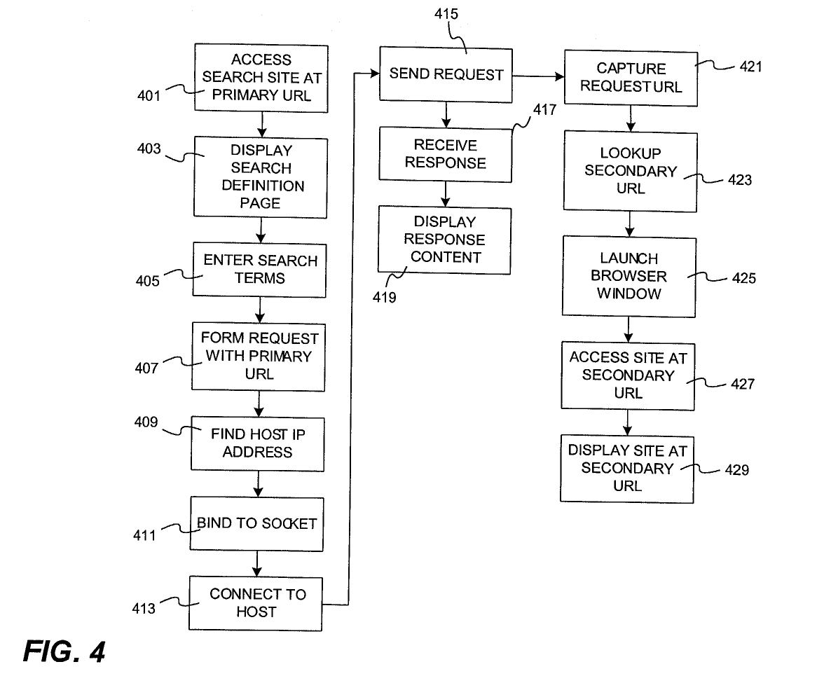

FIG. 4 is a flow diagram of processes in an exemplary search transaction in accordance with an embodiment of the present invention. At process 401, a user accesses a search site such as currently found at http://www.altavista.com or http://www.yahoo.com and the like. The target URL of the search request is referred to herein as the “primary” URL. Process 401 is typically performed by sending an HTTP request using a conventional web browser, but it is contemplated that special purpose, branded, or configured browser software may be used, or that a dedicated search site access program may be used. The search engine will typically generate an HTTP response containing an HTML page to the process operating on the user's machine.

In process 403, the response page is displayed on the user's machine to display a search definition page. typically the search definition page includes input controls that enable a user to enter search terms and search operators such as “and”, “or” and the like in process 405. The search definition page will also include a submit control such as an “OK” or “SEARCH” button that can be activated using a mouse, keyboard or other user input mechanism available on the user's machine. Activation of the submit control causes the user's machine to generate an HTTP request embedding a search request addressed to the primary URL.

Processes 409, 411, 413 and 415 are substantially conventional processes handled by a browser used to resolve the primary URL into an IP address, instantiate and bind the HTTP request to a network socket protocol, connect to a host at the IP address and send the request using available network protocols. These processes may occur in a different order in some protocols and connectionless protocols such as IP may not require or permit a host connection, and so may omit step 413.

From process 415, the preferred implementation branches to take two paths in parallel. In process 417, the browser instance used to initiate the request is waits to receive a response from the primary URL. The response, presumably including an HTML page containing search results, is then displayed using the browser in a conventional fashion in process 419. In some instances, an HTTP error page, or an error page generated by the search engine itself may be displayed instead.

In parallel with the display of the search results in step 421, the search assistant software in accordance with the present invention captures the request URL in process 421. In an alternative implementation, the search assistant process captures information from the response received in process 417.

In process 423, the search assistant indexes into a local data structure 207 to determine a secondary URL. In one embodiment a single secondary URL is determined, however, it is contemplated that a plurality of secondary URLs may be determined instead. The secondary URLs point to one or more web servers that provide content associated with the search request.

In process 425, a new browser instance is launched which may be a conventional browser window, or may be constrained to eliminate some user controls and/or menu bars, or enhanced with user controls and menu bars not otherwise available in a conventional browser window. The new browser instance is pointed to the secondary URL in process 427 and used to display a page from a web server residing at the secondary URL in process 429. Alternatively, step 427 may be implemented by generating an HTML page including one or more secondary URLs. From this locally generated search results page, a user may select one or more of the secondary URLs to effect pointing the new browser instance to the selected secondary URL.

In an alternative embodiment, the branches following step 415 are not performed in parallel, but are instead performed serially using a single browser instance. For example, the search request causes control to flow only to process 421, resulting in the determination and display of the secondary URLs without actually submitting the search request to the server located at the primary URL. In this embodiment, the search results generated by the search assistant preferably includes a control or hyperlink enabling the user to indicate a desire to forward the request on to the server at the primary URL.

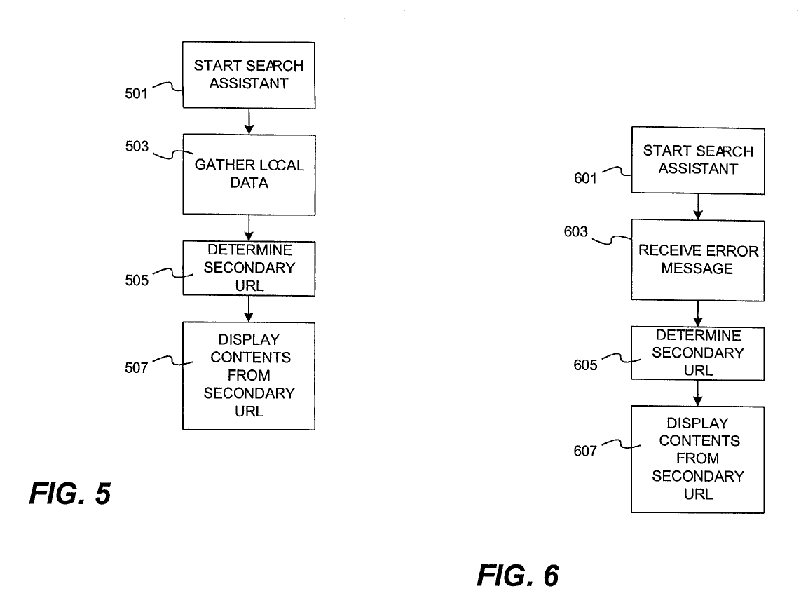

In yet another alternative, the present invention is implemented in a manner that enables the search assistant to be activated in response to stimulus other than a search request entered through a browser. As shown in FIG. 5, search assistant 206 is started or instantiated at 501 and operates in step 503 to gather any type of desired local data. In the earlier examples this local data was a search request entered by a user, however, a wide variety of local data may be useful to search assistant 206. For example, search assistant 206 may be triggered by a timer or by accessing a system clock such that it intermittently determines a secondary URL based on the time or date in process 505, and launches a GUI window displaying content from the secondary URL in step 507. Other information may be used to trigger search assistant 206 as well. For example, search assistant may perform an analysis of file types stored on the user's machine and use the file type to determine a secondary URL in process 505.

In another example, search assistant 206 may perform an analysis of words stored in word processing data files (e.g., documents) stored on the user machine, and determine a secondary URL based on the word analysis. Such a technique can be very useful in a knowledge management device that operates to analyze the work a user is performing and then automatically and proactively display information to the user that relates to the user's current work. In a law firm, for example, the search assistant can readily determine that many of the user's documents include the phrase “patent infringement” and display a list of pointers to current legal resources related to the issue of patent infringement. In such an implementation, a knowledge specialist may keep the local data structure 207 current and distributed to the end user's machines so that references to relevant materials are automatically and instantly available to a user.

In an alternative shown in FIG. 6, the present invention is implemented in a manner that enables the search assistant to be activated in response to error messages received in responses. In 601, the search assistant is started which typically occurs when a computer is turned on, or when a browser application is launched. When an error message is received as determined by parsing the response message, the local data structure is queried to determine an secondary URL that will deliver an appropriate response. A single URL may be used for all error messages, or different URLs may be selected depending on the type of error. Moreover, the secondary URL may be selected based on the domain of the request or response either alone, or in combination with the type of error. For example, a 404 message may be associated with a secondary URL that points to the home page of the domain so that the user can navigate down to the desired resource. Alternatively, the secondary URL associated with a 403 message may point the user to an alternative domain with equivalent content to which the user has permission. In step 607, a GUI window is launched to display the content identified by the secondary URL.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A method of accessing web-based search services from a client computer, the method comprising:
communicating request and response message traffic between at least one instance of a web browser executing on a client computer and a search engine service executing on a web server;
using a client executable process to capture search terms from at least one of the messages; and
using the search terms to index into a local data structure on the client computer and retrieve an address associated with the search terms.

2. The method of claim 1 further comprising displaying the address retrieved from the data structure in a manner that enables selection of the displayed address and direction of the at least one instance of a web browser to the web site associated with the search terms.

3. The method of claim 1 further comprising directing the at least one instance of a web browser to the address of the web site retrieved from the local data structure.

4. The method of claim 1 further comprising launching a new instance of a web browser executing on the client machine; and
displaying the address retrieved from the data structure using the new instance of the web browser in a manner that enables selection of the displayed address and direction of the new instance of a web browser to the web site associated with the search terms.

5. The method of claim 1 further comprising launching a new instance of a web browser executing on the client machine; and
directing the at least one instance of a web browser to the address of the web site retrieved from the local data structure

6. The method of claim 1 further comprising:
using the client executable process to capture a domain name of the search service from at least one of the messages; and,
using the domain name in combination with the captured search terms to index into the local data structure.

7. The method of claim 1 further comprising:
displaying, using a first instance of the web browser, a search results page generated by the search engine service; and
displaying, using a second instance of the web browser, at least a portion of the web site associated with the address retrieved from the local data structure.

8. The method of claim 1 wherein the client executable process captures hypertext transfer protocol (HTTP) response message headers received by the at least one instance of the web browser.

9. The method of claim 1 wherein the client executable process captures hypertext transfer protocol (HTTP) request message headers generated by the at least one instance of the web browser.

10. The method of claim 1 wherein the local data structure comprises a directory.

11. The method of claim 1 further comprising:
periodically updating the local data structure to maintain coherency between the local data structure and a master data structure maintained on a network server.

12. The method of claim 1 further comprising:
periodically updating the client executable process to maintain coherency with a master copy of the client-executable process maintained on a network server.

13. The method of claim 1 wherein the local data structure has a hierarchical structure.

14. The method of claim 1 wherein the local data structure comprises separate hierarchical branches, where each branch corresponds to different web-based search services such that the address retrieved from the data structure is search service-dependent.

15. A computer readable medium comprising:
a data storage structure accessible to processes on a client computer;
a plurality of entries defined in the data storage structure;
first data within each entry containing data representing keywords; and
second data within each entry and associated with the first data, the second data containing data representing a location of a network-accessible resource.

16. The computer readable medium of claim 15 wherein the data representing a location comprises a uniform resource locator (URL).

17. The computer readable medium of claim 15 wherein the network-accessible resource comprises a web site.

18. The computer readable medium of claim 15 further comprising program code stored on the medium and executable by the client computer to access the data storage structure to select an entry using search terms captured from hypertext transfer protocol (HTTP) traffic.

19. The computer readable medium of claim 18 further comprising program code stored on the medium and executable by the client computer to compare the captured search terms to the first data of the entries and return the second data of the selected entry.

20. A computer program device configured to cause a client computer to access a selected web site comprising:
computer code devices configured to cause a client computer to communicate request and response message traffic with an external search engine service executing on a web server;
computer code devices configured to cause the client computer to capture search terms from at least one of the messages;
computer code devices configured to cause the client computer to use the search terms to index into a local data structure on the client computer and retrieve an address of a web site associated with the search terms; and
computer code devices configured to cause the client computer to access the web site at the retrieved address.

21. The computer program device of claim 20 further comprising computer code devices configured to cause the client computer to launch an instance of a web browser executing on the client machine; and
computer code devices configured to cause the client computer to direct the instance of a web browser to the address of the web site retrieved from the local data structure.

22. A client-executable assistant process for augmenting web-based search services, the assistant process comprising:
a data structure including a plurality of key:value pairs, where the key values correspond to search terms and the values correspond to web site locations associated with the key;
a monitoring process executing on the client computer and operable to monitor hypertext transfer protocol (HTTP) message headers and capture search terms from HTTP messages exchanged with web-based search services;
a retrieval process executing on the client computer and operable to retrieve a web site location from the data structure by using the captured search terms as an index to select an key:value pair; and
a launch process for launching a web browser window pointing to the retrieved web site location.

23. The client-executable assistant process of claim 22 wherein the monitoring process is further operable to capture a domain name from the message header and the retrieval process is further operable to use the captured domain name to select the key:value pair.

24. The client-executable assistant process of claim 22 wherein the data structure is populated with key-value pairs supplied by an external third-party.

25. The client-executable assistant process of claim 22 further comprising an update process executing on the client computer to periodically cohere the key-value pairs with a master record of key:value pairs maintained in an external, network-accessible server.

26. The client-executable assistant process of claim 22 wherein the keys comprise generic words likely to be used by users looking for topics of interest.

27. A system for locating network content, the system comprising:
a plurality of network-accessible search engine servers;
a client configured to send search request messages to the network-accessible search engine servers and receive response messages containing search results from the search engine servers; and
an assistant process executing on the client for capturing search terms from at least one of the request messages and response messages and using the captured search terms, locating a network resource associated with the search terms.
